(19) United States
(12) Patent Application Publication
(10) Pub. No.: US 2026/0076877 A1
(43) Pub. Date: Mar. 19, 2026

(54) Teether Capable Of Alleviating Teething Discomfort

(71) Applicant: Shenzhen Kean Silicone Product Co.,Ltd., Shenzhen (CN)

(72) Inventor: Pandian Peng, Shenzhen (CN)

(73) Assignee: Shenzhen Kean Silicone Product Co.,Ltd., Shenzhen (CN)

(21) Appl. No.: 18/890,229

(22) Filed: Sep. 19, 2024

(51) Int. Cl. A61J 17/02

(52) U.S. Cl. CPC A61J 17/02

(57) ABSTRACT

Disclosed is a teether capable of alleviating teething discomfort, including a teether body. The teether body is made of a soft material. The teether body includes a biting seat and an end cap. The biting seat and the end cap are connected in a sealed manner. A liquid storage cavity for containing harmless liquid is formed in the biting seat, the end cap is provided with a liquid injection port, and the liquid injection port is communicated with the liquid storage cavity. A sealing cover for blocking the liquid injection port is further included, and the sealing cover can be connected with the liquid injection port in a sealed manner. The sealing cover and the liquid injection port can be detachably connected in a sealed manner, which facilitates replacement of the harmless liquid inside the teether body, is cost-effective and has broad application prospects.

### TECHNICAL FIELD

The present disclosure relates to the technical field of teething tools, and particularly relates to a teether capable of alleviating teething discomfort.

### BACKGROUND

Teethers, also known as teething sticks, teething devices, tooth fixers and dental training devices. Most of the teethers are made of safe and non-toxic silicone, and some of them are made of soft plastic. They are shaped like fruits, animals, pacifiers, cartoon characters, and the like, showing diversity of designs. When teething, babies exhibit irritability, excessive drooling, biting preferences, and other habits. By biting teethers, babies can massage their gums, which will alleviate their teething discomfort to a certain extent.

However, teethers currently on the market have only simple structures and basic biting functions, which have relatively weak effects on alleviating teething discomfort, and fail to meet user needs. Therefore, there is an urgent need to improve structures of teethers in the prior art to better alleviate the teething discomfort of babies.

### SUMMARY

To solve part or all of the problems existing in the prior art, the present disclosure provides a teether capable of alleviating teething discomfort, and the teether includes a teether body. The teether body is made of a soft material. The teether body includes a biting seat and an end cap. The biting seat and the end cap are connected in a sealed manner. A liquid storage cavity for containing harmless liquid is formed in the biting seat, the end cap is provided with a liquid injection port, and the liquid injection port is communicated with the liquid storage cavity. A sealing cover for blocking the liquid injection port is further included, and the sealing cover can be connected with the liquid injection port in a sealed manner.

As a further improvement to the present disclosure, an end face of the biting seat close to one end of the end cap is provided with a snap-fit boss, and the end cap is provided with a snap-fit groove that is in fit with the snap-fit boss, where glue is filled between the snap-fit boss and the snap-fit groove.

As a further improvement to the present disclosure, an end face of the snap-fit boss close to one end of the snap-fit groove is provided with a glue storage plane, and the glue storage plane is adhesively bonded with an inner side wall of the snap-fit groove for sealing.

As a further improvement to the present disclosure, a first baffle wall that is communicated with the liquid storage cavity is arranged in the biting seat, a positioning table is arranged at a position of the end cap corresponding to the first baffle wall, and the first baffle wall is capable of abutting against the positioning table.

As a further improvement to the present disclosure, the end cap is provided with a second baffle wall.

As a further improvement to the present disclosure, a wall thickness of the end cap is greater than that of the biting seat.

As a further improvement to the present disclosure, the wall thickness of the end cap is greater than or equal to 1 mm, and the wall thickness of the biting seat ranges from 0.5 mm to 1.5 mm.

As a further improvement to the present disclosure, a height of an internal gap of the liquid injection port is approximately equal to a cap extension length of the sealing cover.

As a further improvement to the present disclosure, one end of the sealing cover can be inserted into the liquid injection port, and an outer surface of the sealing cover can be in contact with an inner wall or a side wall of the liquid injection port.

As a further improvement to the present disclosure, a plurality of biting protrusions are arranged on an outer side wall of the biting seat, and the biting protrusions are distributed on one side of the biting seat that is away from the end cap respectively.

As a further improvement to the present disclosure, a handheld part that is movably snap-fitted with the teether body is further included, and both the handheld part and the teether body are made of a silicone material.

As a further improvement to the present disclosure, one end of the handheld part is provided with an opening, and one end of the teether body is snapped into the opening.

As a further improvement to the present disclosure, a curved side wall of the end cap is fitted with a curved inner wall of the opening.

As a further improvement to the present disclosure, an outer side wall of the end cap is provided with a protruding strip for limiting the handheld part, and the protruding strip is capable of abutting against the handheld part.

As a further improvement to the present disclosure, the handheld part is provided with a plurality of anti-slip protrusions.

Compared with the prior art, the present disclosure has the beneficial effects as follows: the design of filling the harmless liquid inside the teether body allows for long-time ice compressing of a baby's gums after refrigeration, thereby effectively alleviating the teething discomfort of the baby. The sealing cover and the liquid injection port can be detachably connected, which facilitates replacement of the harmless liquid inside the liquid storage cavity, is cost-effective and has broad application prospects.

### BRIEF DESCRIPTION OF THE DRAWINGS

In order to more clearly describe the solutions in the present disclosure or in the prior art, a brief introduction to the accompanying drawings required for the description of the embodiments or the prior art will be made below. Apparently, the accompanying drawings in the following description are merely some embodiments of the present disclosure, and those of ordinary skill in the art would also be able to derive other drawings from these drawings without making creative efforts.

FIG. 1 is a schematic diagram of a breakdown structure according to an example of the present disclosure.

FIG. 2 is a schematic diagram of a three-dimensional structure of a teether body according to an example of the present disclosure.

FIG. 3 is a schematic diagram of an overhead structure of a teether body according to an example of the present disclosure.

FIG. 4 is a schematic diagram of a sectional structure of the present disclosure in an A-A direction in FIG. 3.

FIG. 5 is a schematic diagram of an enlarged structure of a portion C in FIG. 4.

FIG. 6 is a schematic diagram of a sectional structure of the present disclosure in a B-B direction in FIG. 3.

FIG. 7 is a structural schematic diagram of an end cap according to an example of the present disclosure.

FIG. 8 is a schematic diagram of an internal structure of a teether body after a sealing cover is inserted into a liquid injection port according to an example of the present disclosure.

### DETAILED DESCRIPTIONS OF THE EMBODIMENTS

Unless defined otherwise, all technical and scientific terms used herein have the same meaning as commonly understood by those skilled in the art to which the present disclosure belongs. The terms used in the specification of the present disclosure is for the purpose of describing specific examples merely and are not intended to limit the present disclosure. The terms “including” and “having”, and any variations thereof in the specification, the claims and the above accompanying drawings are intended to cover non-exclusive inclusion. The terms “first”, “second” and the like in the specification and the claims or the above accompanying drawings are used to distinguish different objects and are not intended to indicate a specific order.

When the term “example” is referred to herein, it means that specific features, structures or characteristics described in combination with the example may be included in at least one example of the present disclosure. When this phrase occurs at various positions in the specification, it neither necessarily refers to the same example, nor refers to an independent or alternative example mutually exclusive to other examples. Those skilled in the art understand both explicitly and implicitly that the embodiments described herein can be combined with other examples.

In order to enable those skilled in the art to better understand the technical solutions of the present disclosure, the technical solutions in the examples of the present disclosure will be clearly and completely described below with reference to the accompanying drawings.

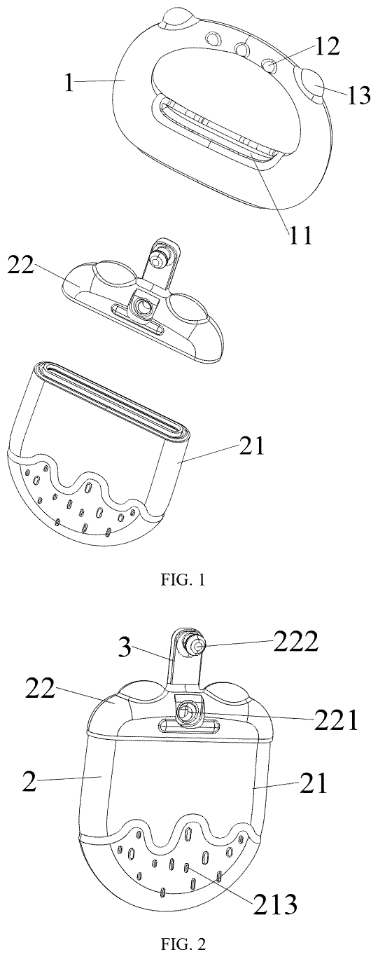

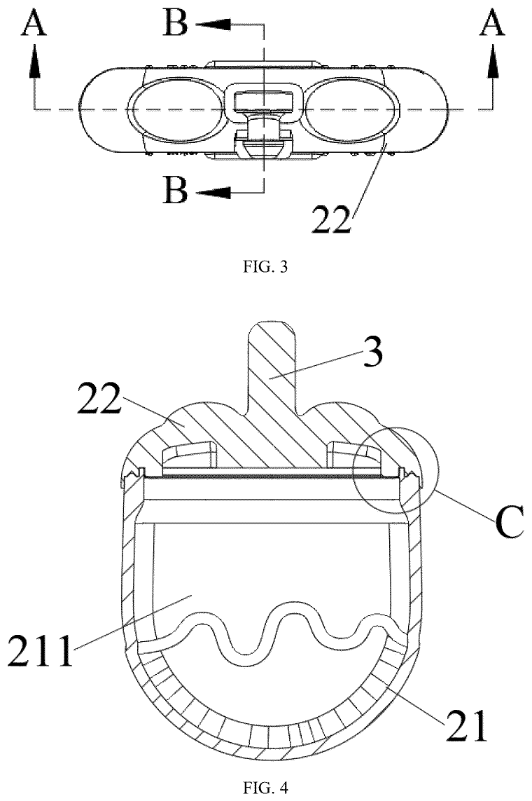

As illustrated in FIGS. 1-8, a teether capable of alleviating teething discomfort includes a handheld part 1 and a teether body 2, where the handheld part 1 is movably snap-fitted with the teether body 2, the teether body 2 is configured for a baby to bite, and the handheld part 1 facilitates holding of the teether by the baby, thereby enhancing practicality. In this example, both the teether body 2 and the handheld part 1 are made of a soft silicone material.

As illustrated in FIGS. 2, 5 and 7, the teether body 2 includes a biting seat 21 and an end cap 22. A liquid storage cavity 211 for containing harmless liquid is formed in the biting seat 21, the end cap 22 is provided with a liquid injection port 221, and the liquid injection port 221 is communicated with the liquid storage cavity 211. The liquid injection port 221 is arranged to facilitate infusion of the harmless liquid into the liquid storage cavity 211. The end cap 22 is provided with a connecting bar 3, the connecting bar 3 is provided with a sealing cover 222 for blocking the liquid injection port 221, and the sealing cover 222 can be connected with the liquid injection port 221 in a sealed manner. The sealing cover 222 is arranged to encapsulate the harmless liquid in the liquid storage cavity 211.

In a specific implementation process, the harmless liquid includes purified water, sterile distilled water, or any other sterile and non-toxic liquid. In a specific implementation process, the teether body 2 can be used independently and in multiple scenarios, and is compact and easy to carry. The teether body 2 occupies a small space when placed in a refrigerator, thereby allowing placement of more teether bodies 2.

It should be noted that the design of filling the harmless liquid inside the teether body 2 allows for long-time ice compressing of a baby's gums after refrigeration, thereby effectively alleviating the teething discomfort of the baby.

In a specific implementation process, the sealing cover 222 and the liquid injection port 221 can be detachably connected, and by opening the sealing cover 222, the harmless liquid in the liquid storage cavity 211 can be poured out, which facilitates replacement of the harmless liquid inside the liquid storage cavity 211, is cost-effective and has broad application prospects.

As illustrated in FIG. 2, in this example, the end cap 22, the connecting strip 3 and the sealing cover 222 form an integrated structure, thereby reducing assembly difficulty and improving efficiency. In other examples, the end cap 22, the connecting strip 3 and the sealing cover 222 can also be mutually independent components that are fixedly connected through bonding or other means.

As illustrated in FIGS. 2, 4, and 5, in this example, the biting seat 21 and the end cap 22 are adhesively bonded with each other for sealing and fixing. Specifically, an end face of the biting seat 21 close to one end of the end cap 22 is provided with a snap-fit boss 214, and the end cap 22 is provided with a snap-fit groove 224 that is in fit with the snap-fit boss 214, where glue is filled between the snap-fit boss 214 and the snap-fit groove 224. The snap-fit boss 214 and the snap-fit groove 224 are arranged to increase an area of contact between the biting seat 21 and the end cap 22, so as to increase a coverage area of the glue and enhance structural stability of adhesive bonding between the end cap 22 and the biting seat 21.

In one example, an end face of the snap-fit boss 214 close to one end of the snap-fit groove 224 is provided with a glue storage plane 215, and the glue storage plane 215 is adhesively bonded with an inner side wall of the snap-fit groove 224 for sealing. The glue storage plane 215 is arranged to facilitate injection of the glue onto the snap-fit boss 214 during assembly; and further, injection of the glue onto the glue storage plane 215 also facilitates extrusion of the glue into the entire snap-fit boss 214 and the snap-fit groove 224 when the end cap 22 and the biting seat 21 are adhesively bonded in a compressional manner, which enhances a strength and effect of the adhesive bonding and ensures the firm adhesive bonding between the end cap 22 and the biting seat 21.

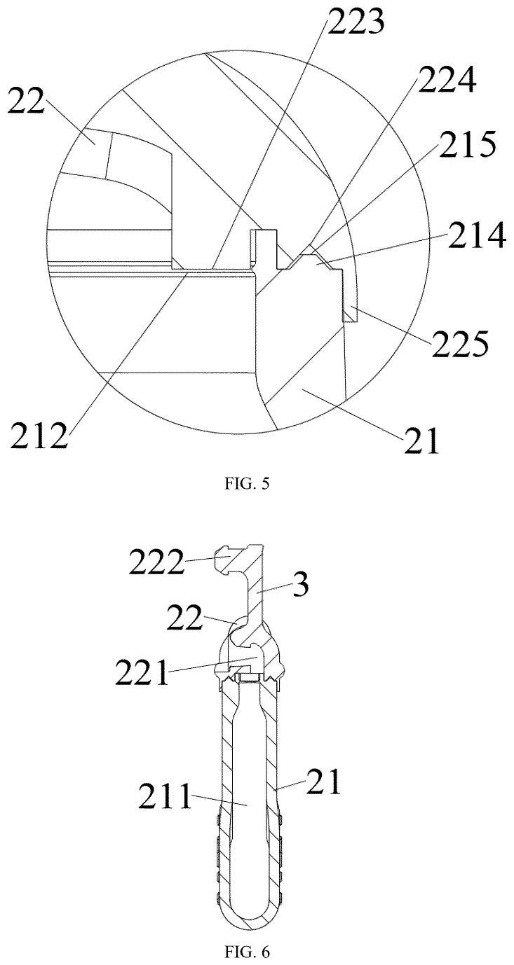

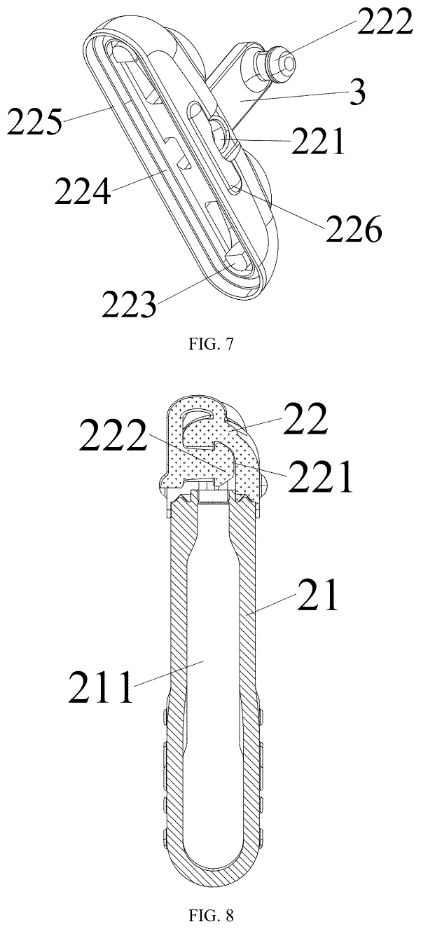

As illustrated in FIGS. 5 and 7, a first baffle wall 212 that is communicated with the liquid storage cavity 211 is arranged in the biting seat 21, a positioning table 223 is arranged at a position of the end cap 22 corresponding to the first baffle wall 212, and the first baffle wall 212 is capable of abutting against the positioning table 223. It should be noted that positioning cooperation between the positioning table 223 and the first baffle wall 212 facilitates installation of the end cap 22 onto the biting seat 21. The first baffle wall 212 with a blocking effect is capable of preventing the glue from mixing with the harmless liquid in the liquid storage cavity 211.

As illustrated in FIGS. 5 and 7, the end cap 22 is provided with a second baffle wall 225. It should be noted that arrangement of the second baffle wall 225 facilitates the blocking of any glue overflowed from the snap-fit groove 224, and further enhances an adhesive bonding strength between the end cap 22 and the biting seat 21.

As illustrated in FIG. 6, to prevent the biting seat 21 from becoming hard after refrigeration, an overall wall thickness of the biting seat 21 should be minimized as much as possible. However, since the end cap 22 is provided with the sealing cover 222, if the end cap 22 is too thin, deformation is likely to occur when the sealing cover 222 is pressed, such that the sealing cover 222 cannot fully seal the liquid injection port 221. Therefore, in this example, a wall thickness of the end cap 22 is greater than that of the biting seat 21; and the wall thickness of the end cap 22 is greater than or equal to 1 mm, and the wall thickness of the biting seat 21 ranges from 0.5 mm to 1.5 mm.

As illustrated in FIG. 8, a height of an internal gap of the liquid injection port 221 is approximately equal to a cap extension length of the sealing cover 222, one end of the sealing cover 222 can be inserted into the liquid injection port 221, and an outer surface of the sealing cover 222 can be in contact with an inner wall or a side wall of the liquid injection port 221. In actual operations, after the sealing cover 222 is inserted into the liquid injection port 221, the sealing cover 222 is compressed to enable the outer surface of the sealing cover 222 to abut against and fit with a lower inner wall of the liquid injection port 221, such that the sealing cover 222 and the liquid injection port 221 are securely connected in an inserted manner, thereby reducing the likelihood of disengagement and preventing possible liquid leakage.

It should be noted that after the sealing cover 222 is inserted into the liquid injection port 221, part of the outer surface of the sealing cover 222 inevitably is not in contact with an inner side wall of the liquid injection port 221. However, even if the outer surface of the sealing cover 222 is not in contact with the liquid injection port 221, a gap between them cannot exceed 5 mm, to ensure that when a baby's biting behavior causes the deformation, the harmless liquid in the liquid storage cavity 211 will not flow out, thereby enhancing sealing effectiveness of the liquid injection port 221.

As illustrated in FIG. 2, a plurality of biting protrusions 213 are arranged on an outer side wall of the biting seat 21, and the biting protrusions 213 are distributed on one side of the biting seat 21 that is away from the end cap 22 respectively. The biting protrusions 213 are arranged. In use, the biting protrusions 213 effectively contact and massage teething areas on both sides of a baby's milk teeth, which is capable of further alleviating the teething discomfort of the baby.

As illustrated in FIG. 1, one end of the handheld part 1 is provided with an opening 11, and one end of the teether body 2 is snapped into the opening 11. In a specific implementation process, the sealing cover 222 is located inside the opening 11, to further enhance the sealing effectiveness of the teether body 2.

A curved side wall of the end cap 22 is fitted with a curved inner wall of the opening 11. It should be noted that since the curved side wall of the end cap 22 is fitted with the curved inner wall of the opening 11, the teether body 2 can be easily snap-fitted with the handheld part 1 in an embedded manner, thereby facilitating pulling of the teether body 2 from the handheld part 1 in an inclined manner.

As illustrated in FIG. 7, an outer side wall of the end cap 22 is provided with a protruding strip 226 for limiting the handheld part 1, and the protruding strip 226 is capable of abutting against the handheld part 1. In use, when the teether body 2 is inserted into the opening 11 of the handheld part 1, the protruding strip 226 will appropriately compress the opening 11 of the handheld part 1 until the opening 11 of the handheld part 1 crosses the protruding strip 226, and the protruding strip 226 abuts against a side wall of the handheld part 1, to complete assembly of the handheld part 1 with the teether body 2. The protruding strip 226 is arranged on the end cap 22, to cause the handheld part 1 and the teether body 2 to be fixed in a snapped manner, so as to prevent unnecessary disengagement of the handheld part 1, thereby enhancing the structural stability.

As illustrated in FIG. 1, the handheld part 1 is provided with a plurality of anti-slip protrusions 12. In a specific implementation process, one side of the handheld part 1 is provided with three of the anti-slip protrusions 12 arranged at an equal interval, and the other side of the handheld part 1 is also provided with three of the anti-slip protrusions 12 arranged at an equal interval. Arrangement of the anti-slip protrusions 12 increases friction between a baby's hand and the handheld part 1, thereby facilitating the baby's holding of the handheld part 1. The anti-slip protrusions 12 and the handheld part 1 form an integrated structure.

As illustrated in FIG. 1, the handheld part 1 is provided with limiting protrusions 13, and the limiting protrusions 13 are distributed around a periphery of the anti-slip protrusions 12. In a specific implementation process, the limiting protrusions 13 and the handheld part 1 form an integrated structure, the number of the limiting protrusions 13 is two, the anti-slip protrusions 12 are located between the two limiting protrusions 13, and the arrangement of the limiting protrusions 13 helps a user to quickly locate a desired position of holding the handheld part 1. The arrangement of the anti-slip protrusions 12 and the limiting protrusions 13 facilitates chewing of convex portions, which better alleviates gum pain.

Working principle: the design of filling the harmless liquid inside the teether body 2 allows for long-time ice compressing of a baby's gums after refrigeration, thereby effectively alleviating the teething discomfort of a baby. The sealing cover 222 and the liquid injection port 221 can be detachably connected, which facilitates replacement of the harmless liquid inside the liquid storage cavity 211, is cost-effective and has broad application prospects. A detachable connection between the handheld part 1 and the teether body 2 facilitates refrigeration of a plurality of teether bodies 2 by a user simultaneously. Further, the handheld part 1 facilitates the holding by a baby, thereby enhancing the practicality.

The above specific embodiments are preferred embodiments of the present disclosure and are not intended to limit a specific implementation scope of the present disclosure. The scope of the present disclosure includes, but is not limited to, the specific embodiments, and any equivalent changes made according to the present disclosure fall within the protection scope of the present disclosure.

What is claimed is:

1. A teether capable of alleviating teething discomfort, comprising a teether body, wherein the teether body is made of a soft material, the teether body comprises a biting seat and an end cap, the biting seat and the end cap are connected in a sealed manner, a liquid storage cavity for containing harmless liquid is formed in the biting seat, the end cap is provided with a liquid injection port, and the liquid injection port is communicated with the liquid storage cavity; and
a sealing cover for blocking the liquid injection port is further comprised, and the sealing cover can be connected with the liquid injection port in a sealed manner.

2. The teether capable of alleviating teething discomfort according to claim 1, wherein an end face of the biting seat close to one end of the end cap is provided with a snap-fit boss, and the end cap is provided with a snap-fit groove that is in fit with the snap-fit boss, wherein glue is filled between the snap-fit boss and the snap-fit groove.

3. The teether capable of alleviating teething discomfort according to claim 2, wherein an end face of the snap-fit boss close to one end of the snap-fit groove is provided with a glue storage plane, and the glue storage plane is adhesively bonded with an inner side wall of the snap-fit groove for sealing.

4. The teether capable of alleviating teething discomfort according to claim 2, wherein a first baffle wall that is communicated with the liquid storage cavity is arranged in the biting seat, a positioning table is arranged at a position of the end cap corresponding to the first baffle wall, and the first baffle wall is capable of abutting against the positioning table.

5. The teether capable of alleviating teething discomfort according to claim 4, wherein the end cap is provided with a second baffle wall.

6. The teether capable of alleviating teething discomfort according to claim 1, wherein a wall thickness of the end cap is greater than that of the biting seat.

7. The teether capable of alleviating teething discomfort according to claim 6, wherein the wall thickness of the end cap is greater than or equal to 1 mm, and the wall thickness of the biting seat ranges from 0.5 mm to 1.5 mm.

8. The teether capable of alleviating teething discomfort according to claim 1, wherein a height of an internal gap of the liquid injection port is approximately equal to a cap extension length of the sealing cover.

9. The teether capable of alleviating teething discomfort according to claim 8, wherein one end of the sealing cover can be inserted into the liquid injection port, and an outer surface of the sealing cover can be in contact with an inner wall or a side wall of the liquid injection port.

10. The teether capable of alleviating teething discomfort according to claim 1, wherein a plurality of biting protrusions are arranged on an outer side wall of the biting seat, and the biting protrusions are distributed on one side of the biting seat that is away from the end cap respectively.

11. The teether capable of alleviating teething discomfort according to according to claim 1, wherein a handheld part that is movably snap-fitted with the teether body is further comprised, and both the handheld part and the teether body are made of a silicone material.

12. The teether capable of alleviating teething discomfort according to according to claim 11, wherein one end of the handheld part is provided with an opening, and one end of the teether body is snapped into the opening.

13. The teether capable of alleviating teething discomfort according to according to claim 12, wherein a curved side wall of the end cap is fitted with a curved inner wall of the opening.

14. The teether capable of alleviating teething discomfort according to according to claim 11, wherein an outer side wall of the end cap is provided with a protruding strip for limiting the handheld part, and the protruding strip is capable of abutting against the handheld part.

15. The teether capable of alleviating teething discomfort according to claim 11, wherein the handheld part is provided with a plurality of anti-slip protrusions.
